(19) United States
(12) Patent Application Publication
(10) Pub. No.: US 2025/0185050 A1
(43) Pub. Date: Jun. 5, 2025

(54) METHOD OF ALLOCATING UPLINK RESOURCE THROUGH BUFFER ESTIMATION AND BASE STATION DEVICE USING THE METHOD

(71) Applicant: Seoul National University R&DB Foundation, Seoul (KR)

(72) Inventors: Sae Woong BAHK, Seoul (KR); Good Sol LEE, Seoul (KR); Kyung Han LEE, Seoul (KR); Se Yeon KIM, Seoul (KR); Jong Yun LEE, Seoul (KR); Sang Hyun HAN, Seoul (KR); Seong Sik CHO, Seoul (KR)

(73) Assignee: Seoul National University R&DB Foundation, Seoul (KR)

(21) Appl. No.: 18/931,075

(22) Filed: Oct. 30, 2024

(30) Foreign Application Priority Data
Dec. 4, 2023 (KR) 10-2023-0173685

(51) Int. Cl. H04W 72/52; H04W 28/02; H04W 72/1268

(52) U.S. Cl. CPC H04W 72/52; H04W 28/0278; H04W 72/1268

(57) ABSTRACT

In the present invention, a buffer state of a mobile terminal is estimated based on a traffic pattern identified by profiling traffic of the mobile terminal to then preemptively allocate a resource. In order to prevent an allocated radio resource from being wasted, a resource requested through a buffer state report or the like is first allocated, and the remaining resources are preemptively allocated according to the estimated buffer state.

### CROSS-REFERENCE TO RELATED APPLICATION(S)

This application claims priority from Korean Patent Application No. 10-2023-0173685, filed on Dec. 4, 2023, in the Korean Intellectual Property Office, the disclosure of which is incorporated herein by reference in its entirety.

### BACKGROUND

### 1. Field

The following description relates to a wireless communication technology, and more specifically, to a technology in which a base station estimates a buffer state of a mobile terminal and preemptively allocates an uplink resource.

### 2. Description of Related Art

In long-term evolution (LTE) and 5G cellular systems, a mobile terminal reports a buffer state to a base station to transmit data through an uplink and requests radio resource allocation.

A buffer state reporting procedure is a procedure that notifies a base station of information about how much data, which is to be transmitted to a buffer, a mobile terminal has. For this purpose, the mobile terminal transmits a buffer state report (BSR) message to the base station.

When a mobile terminal does not have no allocated radio resource, the mobile terminal is allocated with a radio resource through a scheduling request (SR). A mobile terminal receives information about a resource block to be allocated to the mobile terminal through an uplink grant and transmits data and a BSR through the corresponding resource block.

A mobile terminal receives a radio resource from a base station in such a responsive manner.

Video-based real-time communication (RTC) for video conferences and video analysis requires both a low transmission delay and a queuing delay to meet stringent application requirements. Despite a 5G wide bandwidth and congestion control algorithms (CCAs) that have been thought to meet the such application requirements, in fact, it appears that such applications do not fully utilize the 5G bandwidth.

This is due to a mismatch between a congestion control algorithm and an uplink scheduler. Currently, an uplink scheduler of a base station allocates radio resources proportional to a reported uplink buffer size in a responsive manner, while a congestion control algorithm attempts to keep a buffer low. Thus, there are problems in that a scheduling delay occurs, and resources, which are lower than resources available for low-buffer application traffic, are allocated.

There is a need for a method of allocating an uplink resource, which is capable of solving such inconsistency problems and improving radio resource utilization of RTC applications in an uplink of 5G.

### SUMMARY

The present invention is directed to providing a method of allocating an uplink resource, which is capable of transmitting packets of a video-based real-time communication application without delay through preemptive radio resource allocation using buffer estimation.

The present invention is also directed to providing a method of allocating an uplink resource, which is capable of minimizing resource waste due to uncertain estimation even when a radio resource is preemptively allocated through buffer estimation.

A method of allocating an uplink resource according to one aspect of the present invention is a method of preemptively allocating an uplink resource through buffer estimation of a mobile terminal in a base station device of a cellular communication system and includes a traffic profiling operation, a buffer state estimating operation, and an uplink resource allocating operation

The traffic profiling operation is an operation of profiling traffic received from a mobile terminal allocated with an uplink resource

The buffer state estimating operation is an operation of predicting a traffic pattern based on the traffic profiling and estimating a buffer state according to the predicting; and

The uplink resource allocating operation is an operation of allocating an uplink resource to the mobile terminal according to the estimated buffer state.

The method may further include a preemptive uplink resource calculating operation.

The preemptive uplink resource calculating operation may be an operation of, after the buffer state estimating operation, calculating an amount of an uplink resource to be preemptively allocated based on an amount of an uplink resource requested to be allocated according to an amount of an allocatable uplink resource and a buffer state reported through a buffer state report (BSR),

In this case, in the uplink resource allocating operation, the uplink resource requested through the BSR may be first allocated, and then the uplink resource may be preemptively and additionally allocated in a range of the calculated amount of the uplink resource to be preemptively allocated.

In the method of allocating an uplink resource according to one aspect of the present invention, in the traffic profiling operation, when a traffic pattern periodically repeats on- and off-periods, the traffic pattern may be profiled with information including a length of the on-period, a length of the off-period, and an amount of traffic in the on-period.

When the traffic pattern periodically repeats the on- and off-periods, in the buffer state estimating operation, an estimate is performed such that a buffer size gradually increases during the off-period.

In a method of allocating an uplink resource according to according to another aspect of the present invention, in the traffic profiling operation, the traffic may be profiled from buffer size information included in an uplink resource allocation request received from the mobile terminal.

A base station device for allocating an uplink resource through buffer estimation according to one aspect of the present invention includes a traffic profiling unit, a buffer state estimating unit, and an uplink resource scheduler.

The traffic profiling unit profiles traffic received from a mobile terminal allocated with an uplink resource.

The buffer state estimating unit predicts a traffic pattern based on the traffic profiling and preemptively estimates a buffer state according to the prediction.

The uplink resource scheduler preemptively allocates a cellular uplink resource to the mobile terminal according to the estimated buffer state.

The base station device according to one aspect of the present invention may further include an uplink resource calculating unit.

After the buffer state is estimated, the uplink resource calculating unit calculates an amount of an uplink resource to be preemptively allocated based on an amount of an uplink resource requested to be allocated according to an amount of an allocatable uplink resource and a buffer state reported through a BSR.

The uplink resource scheduler may first allocate the uplink resource requested through the BSR and may preemptively and additionally allocate the uplink resources in a range of the calculated amount of the uplink resources to be preemptively allocated.

The traffic profiling unit of the base station device according to one aspect of the present invention may profile a traffic pattern, which periodically repeats on- and off-periods, with information including a length of the on-period, a length of the off-period, and an amount of traffic in the on-period.

When the traffic pattern periodically repeats the on- and off-periods, the buffer state estimating unit may perform an estimate such that a buffer size gradually increases during the off-period.

The traffic profiling unit of a base station device according to another aspect of the present invention may profile the traffic from buffer size information included in a resource allocation request received from the mobile terminal.

### BRIEF DESCRIPTION OF THE DRAWINGS

FIG. 1 illustrates an uplink resource allocation procedure in the conventional 5G cellular system.

FIG. 2 is a flowchart of a method of allocating an uplink resource of the present invention.

FIG. 3 conceptually illustrates a method of allocating an uplink resource of the present invention.

FIGS. 4a and 4b show an exemplary comparison between buffer states in reactive scheduling and preemptive scheduling.

FIG. 5 is a block diagram of a base station device performing a method of allocating an uplink resource of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects are specified through embodiments described with reference to the accompanying drawings. It will be understood that the components of each embodiment are possible in various combinations within the embodiments as long as there is no other comment or mutual contradiction. Each block of block diagrams may represent a physical component in some cases but may be a logical representation of part of functions of a physical component or a function performed by a plurality of physical components. In some cases, an entity of a block or part thereof may be a set of program instructions. All or some of such blocks may be implemented by hardware, software, or a combination thereof.

In this specification, a cellular system refers to a mobile communication system that provides various communication services such as voice and packet data and includes a mobile terminal and a base station (BS).

A comprehensive concept of a mobile terminal may be a terminal (user equipment (UE)) in a cellular system and may include a UE, a machine type communication (MTC) device in wideband code division multiple access (WCDMA), long-term evolution (LTE), 5G (New Radio), or the like, or a mobile station, a user terminal (UT), or the like in Global System for Mobile (GSM).

A BS device is a device that communicates with a mobile terminal and includes Node-B, eNB, and gNB.

In the present specification, the terms “resource” and “resources” are used interchangeably.

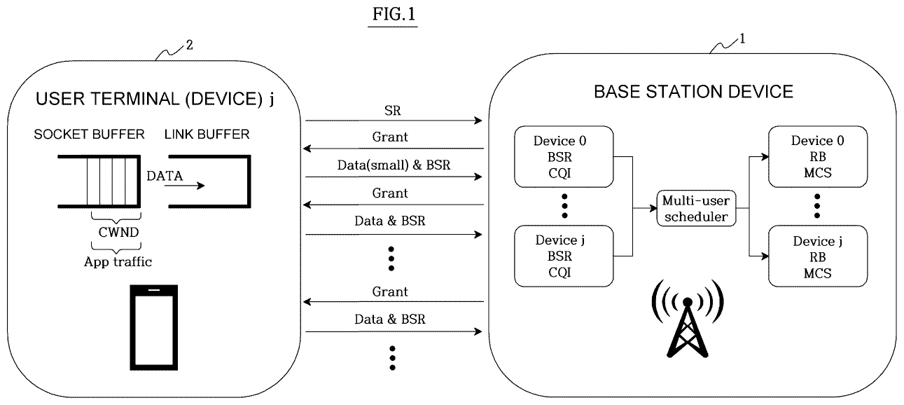

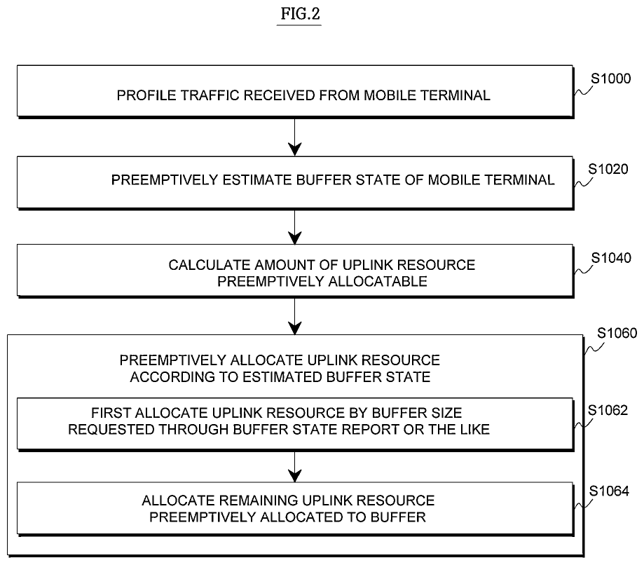

FIG. 1 illustrates an uplink resource allocation procedure in a conventional 5G cellular system. The uplink resource allocation procedure in the conventional 5G cellular system will be described with reference to FIG. 1. In a cellular system, a BS device 1 allocates radio resources for both a downlink and an uplink to a user terminal 2. The BS device 1 may allocate a radio resource to the user terminal 2 for downlink traffic based on an internally known buffer state for a downlink. On the other hand, since the BS device 1 cannot know a buffer state of the user terminal 2 until information about an uplink is received from the user terminal 2, an uplink scheduler allocates a resource in a responsive manner through an additional scheduling procedure to obtain a buffer state of a terminal. FIG. 1 illustrates an uplink resource allocation procedure when new application traffic occurs in the user terminal 2.

Specifically, when a socket buffer of the user terminal 2 first transmits a packet to an empty link buffer as a congestion window CWND allows, a control delay starts. The user terminal 2 transmits a scheduling request SR to the BS device 1 to notify that a new packet has entered a link buffer. The BS device 1 allocates a small radio resource in response to the SR and transmits information about a radio resource to be allocated to the user terminal 2 through an uplink grant.

The user terminal 2 transmits a small packet including data and a buffer state report BSR to the BS device 1. When the BS device 1 receives the BSR, the BS device 1 allocates a radio resource to an uplink of the corresponding user terminal 2 in consideration of a reported buffer state and transmits information about the radio resource to be allocated to the user terminal 2 through the uplink grant. After the user terminal 2 transmits a packet through the allocated radio resource, the control delay ends.

The BS device 1 allocates an uplink radio resource in a unit of a transport block size (TBS) in consideration of the BSR and channel quality information (CQI) of a plurality of user terminals 2. The TBS is a value obtained by multiplying the number of resource blocks (RBs) by bits per RB. Here, the bits per RB are determined by a modulation and coding system (MCS) level calculated through the CQI.

It may be regarded that a radio transmission delay occurs while the user terminal 2 transmits a packet through a radio resource allocated according to a BSR until there are no packets remaining in a link buffer.

Due to such a scheduling procedure, in application traffic, in a 5G uplink during transmission, there occur two types of delays such as 1) a control delay in an initial scheduling procedure of reporting a current buffer state of the user terminal 2, and 2) a radio transmission delay when a packet is transmitted through a radio resource allocated by the BS device 1.

A method of allocating an uplink resource according to one aspect of the present invention is a method of preemptively allocating an uplink resource through buffer estimation of the mobile terminal 20 by the BS device 10 of a cellular communication system and includes a traffic profiling operation, a buffer state estimating operation, and an uplink resource allocating operation.

The method of allocating an uplink resource of the present invention is a method performed in a medium access control (MAC) layer of the BS device 10, and the mobile terminal 20 or other systems do not need to be modified. That is, the BS device 10 to which the present invention is applied may comply with communication standards.

The traffic profiling operation is an operation in which the BS device 10 profiles traffic received from the mobile terminal 20 allocated with an uplink resource (S1000). The BS device 10 profiles a packet, that is, traffic, transmitted by the mobile terminal 20 allocated with an uplink resource, that is, a transmission block, according to an SR or a BSR. That is, the BS device 10 identifies a traffic pattern, which is transmitted by an application running on the mobile terminal 20, through traffic profiling. For example, when the mobile terminal 20 transmits traffic through real-time communication (RTC), the BS device 10 identifies a traffic pattern, in which traffic is periodically transmitted, from a timing and amount of inflow of traffic in the traffic profiling operation.

In the traffic profiling operation, the BS device 10 may recognize RTC with a traffic pattern that periodically repeats on- and off-periods, may identify a length of the on-period, a length of the off-period, and an amount of traffic in the on-period, and may perform profiling with information including the length of the on-period, the length of the off-period, and the amount of traffic.

In this case, the amount of traffic in the on-period may be an average value obtained by dividing the traffic in the on-period divided by the length of the on-period.

Since a traffic pattern is changed according to an application or an operation of a transmission layer, it is difficult for a BS to predict an exact timing and amount of a traffic arrival, and thus profiling is performed using a general traffic pattern of RTC. That is, the BS device 10 profiles a traffic arrival to obtain a period length of each on-period and an amount of the traffic arrival, thereby modeling a traffic pattern of an RTC application.

In a method of allocating an uplink resource according to another aspect of the present invention, in the traffic profiling operation, traffic may be profiled from buffer size information included in an uplink radio resource allocation request received from the mobile terminal 20.

In the traffic profiling operation, the BS device 10 may profile a traffic pattern by estimating an amount of a traffic arrival from buffer size information included in an SR and a BSR received discontinuously from the mobile terminal 20. <Equation 1> below is a formula for estimating an amount of a traffic arrival.

$${\sum }_{{t}^{′} = t}^{t + k} {A}_{{t}^{′}} \geq F ( {BSR}_{t + k} - 1 ) + 1 - F ( {BSR}_{t} ) + {\sum }_{{t}^{′} = t}^{t + k} {TBS}_{{t}^{′}} \qquad [ Equation 1 ]$$

Here, BSRₜ₊ₖ and BSRₜ are sequential BSRs received at time points t+k and t, respectively, Aₜ is the number of bytes arrived at the time point t, TBSₜ is an allocation amount of a resource at the time point t, and F(·) is a function for converting the BSR into a predefined byte value. A lower limit of a traffic arrival is calculated by subtracting an upper limit of a previous BSR (F(BSRₜ)) from a lower limit of the latest BSR (F(BSRₜ₊ₖ−1)+1). An SR is considered as the lowest value of a BSR, and a traffic arrival detected in an off-period is considered as a start of an on-period. When there is no traffic arrival for 10 ms, it is considered to return to an off-period. An average traffic arrival rate of a corresponding period is calculated by dividing an amount of traffic received during an on-period by the corresponding period. When a traffic arrival rate is calculated, F(BSRₜ₊ₖ−1) is used instead of F(BSRₜ₊ₖ) to prevent resource allocation opportunities from being missed by detecting a low traffic arrival rate. Finally, an off-period is considered as an interval between two on-periods.

The buffer state estimating operation is an operation in which the BS device 10 predicts a traffic pattern based on the traffic profiling and preemptively estimates a buffer state according to the prediction (S1020).

The BS device 10 identifies an on-time period and an amount of a traffic arrival through traffic profiling and then probabilistically preemptively estimates a buffer state according to a traffic pattern of RTC of the current mobile terminal 20. In this case, the BS device 10 may estimate a small amount of buffer in an off-period and predicts a deluge of traffic arrivals in an on-period to estimate a large amount of buffer.

The method of allocating an uplink resource of the present invention generates a statistical model indicating a probability that one period continues. A cumulative distribution function (CDF) of the statistical model is a probability that a corresponding period ends. In the present invention, a statistical probability model of a truncated Gaussian distribution may be generated through a history of a previous on-period. The reason for using the truncated Gaussian distribution in the present invention is that in the case of a traffic pattern of RTC, a probability of switching to a next period rapidly increases over time as compared to when an on- or off-period is first changed.

The BS device 10 calculates an expected traffic arrival amount for each on-period. In order to obtain an average traffic arrival trend, the BS device uses a moving average, in which a traffic arrival amount is exponentially weighted, as the expected traffic arrival amount. This is calculated as eAₜ=αAₜ₋₁+(1−α)eAₜ₋₁ during an on-period. Here, eAₜ is an expected traffic arrival amount at a time point t, and a is a smoothing constant basically set to 0.25. In addition, a traffic arrival amount is probabilistically predicted using a statistical model for each period. During an on-period, it is assumed that packets are received in all slots by the average traffic arrival amount. By using a statistical model, when a cumulative probability of a length of a current on-period is greater than 0.8, the on-period is considered to be ended, and traffic is assumed to no longer arrive. During an off-period, it is considered that a packet is present in a buffer according to a value obtained by multiplying a cumulative probability of a statistical model by eAₜ. Therefore, a resource may be allocated quickly even when traffic arrives earlier due to incorrect prediction or a change in CCA.

When a traffic pattern periodically repeats an on- and off-periods, in the buffer state estimating operation, the BS device 10 may perform an estimate such that a buffer size gradually increases during the off-period. This allows the BS device 10 to estimate an amount of next traffic through traffic profiling, but allows a resource to be quickly allocated even when traffic arrives earlier than expected due to the above-described causes (incorrect prediction or a change in CCA).

The uplink resource allocating operation is an operation in which the BS device 10 preemptively allocates an uplink resource to the mobile terminal 20 according to an estimated buffer state (S1060).

When the BS device 10 preemptively estimates a buffer state, the BS device 10 preemptively allocates a radio resource to the mobile terminal 20. That is, even when the BS device 10 does not receive an uplink radio resource request (SR or BSR) from the mobile terminal 20, the BS device 10 preemptively allocates a radio resource according to an estimated buffer state and transmits an uplink grant to transmit information about a radio resource (transmission block) to be allocated.

Even when the BS device 10 estimates a buffer state, the BS device 100 may receive an SR or BSR from the mobile terminal 20 before preemptively allocating a resource. Even in this case, the BS device 10 may preemptively allocate an uplink resource to the mobile terminal 20 according to the estimated buffer state.

Since the BS device 10 estimates the buffer state based on a predicted traffic pattern, when the prediction is incorrect, a radio resource may be wasted. Therefore, even when the BS device 10 estimates a buffer state and preemptively allocates a resource, it is necessary to ensure that a radio resource of the BS device 10 is not wasted. That is, the BS device 10 requires a method of maximizing an advantage of preemptively allocating a resource through preemptive buffer state estimation and simultaneously minimizing the waste of resources.

The method of allocating an uplink resource according to one aspect of the present invention may further include a preemptive uplink resource calculating operation. The BS device 10 may know a buffer state of the mobile terminals 20 through a resource allocation request (SR or BSR) received from the mobile terminals 20. The known buffer state may be referred to as a reported buffer state and may be considered as a certain buffer state that should be allocated to the mobile terminal 20 by the BS device 10.

A buffer state of the mobile terminal 20, which performs RTC, estimated by the BS device 10, may be referred to as an estimated buffer state and may be considered as an uncertain buffer state.

In the preemptive uplink resource calculating operation after the buffer state estimating operation, the BS device 10 may calculate an amount of an uplink resource to be preemptively allocated based on an amount of an uplink resource requested to be allocated according to an amount of an allocatable uplink resource and a buffer state reported through a BSR (S1040).

In this case, in the uplink resource allocating operation, the BS device 10 may first allocate the uplink resource requested through the BSR (S1062) and then may preemptively and additionally allocate an uplink resource in a range of the calculated amount of the uplink resource to be preemptively allocated.

As described above, the BS device 10 may distinguish a certain buffer state from an uncertain buffer state and may generate two virtual buffer sets such as a certain buffer set and an uncertain buffer set.

In order to prevent resource waste due to incorrect prediction when a radio resource is allocated to the mobile terminal 20 according to an estimated buffer state, the BS device 10 may first allocate a resource to the certain buffer set and then may allocate a resource to the uncertain buffer set in a range of remaining allocable radio resources (S1064).

That is, the BS device 10 sequentially allocates resources to the certain buffer set and the uncertain buffer set. Therefore, the BS device 10 may allocate a resource to the uncertain buffer set only when there are the remaining resources after a resource is allocated to the certain buffer set.

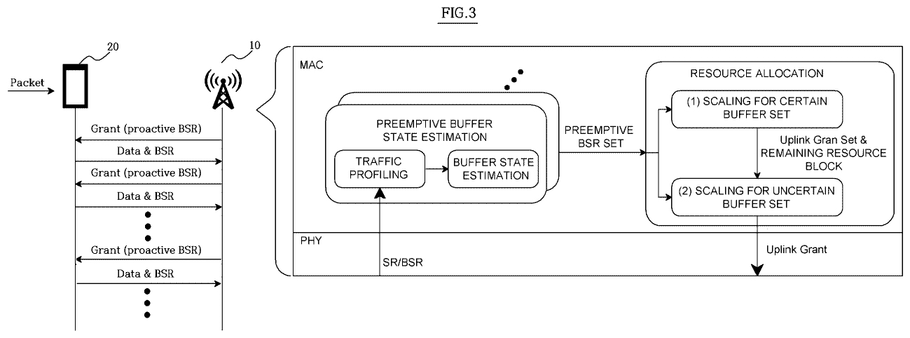

In the example shown in FIG. 3, a procedure in which an application of the mobile terminal 20 starts to transmit traffic and receives an SR and a BSR between the mobile terminal 20 and the BS device 10 is not shown. However, when the BS device 10 profiles traffic from the SR and BSR discontinuously received from the mobile terminal 20 and identifies the profiled traffic as a traffic pattern of RTC, the BS device 10 predicts a buffer state of the mobile terminal 20, preemptively allocates a radio resource based on the predicted buffer state, and transmits an uplink grant. The mobile terminal 20 transmits data and a BSR to the BS using an allocated transmission block. In this case, the BS identifies an exact buffer state through the BSR. In this case, the BS first allocates a radio resource according to a certain buffer state and equally allocates a radio resource to other mobile terminals 20 according to a certain buffer state, and then allocates a radio resource to the mobile terminal as much as the uncertain buffer state when there are the remaining radio resources after a radio resource is allocated according to the certain buffer state (when a BSR is received from the mobile terminal, a resource is additionally allocated by a buffer size obtained by subtracting a buffer size in the certain buffer state from a buffer size in the uncertain buffer state, and when a BSR is not received, a resource is allocated by a buffer size in the uncertain buffer state). The BS device 10 transmits the uplink grant again for the BSR.

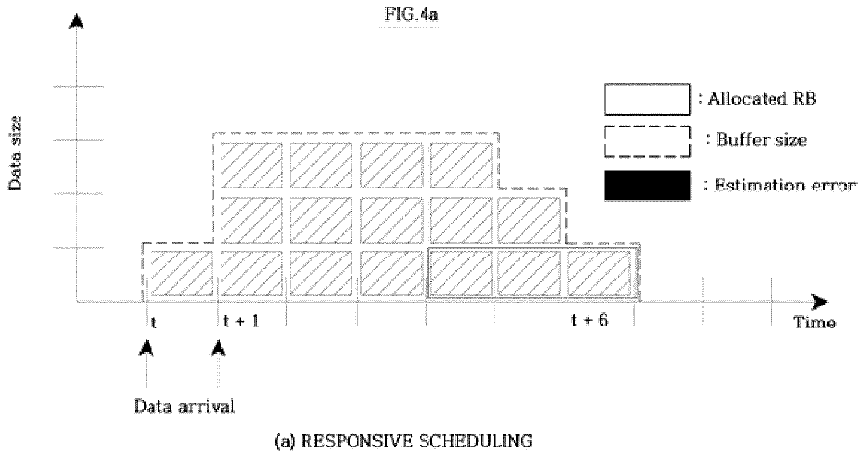

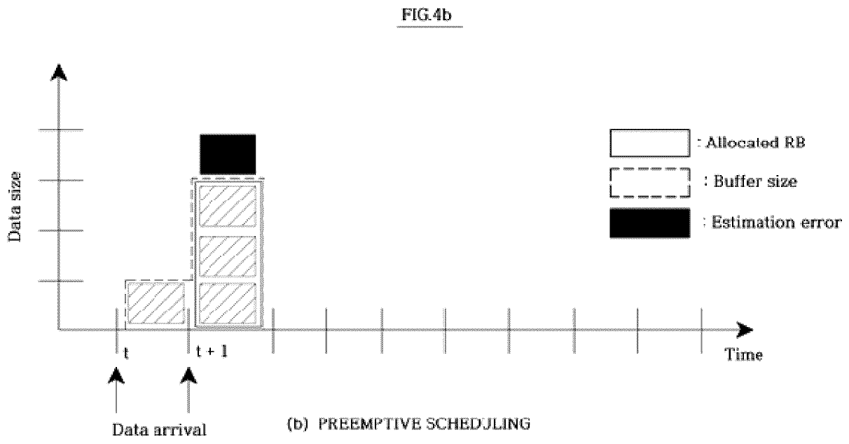

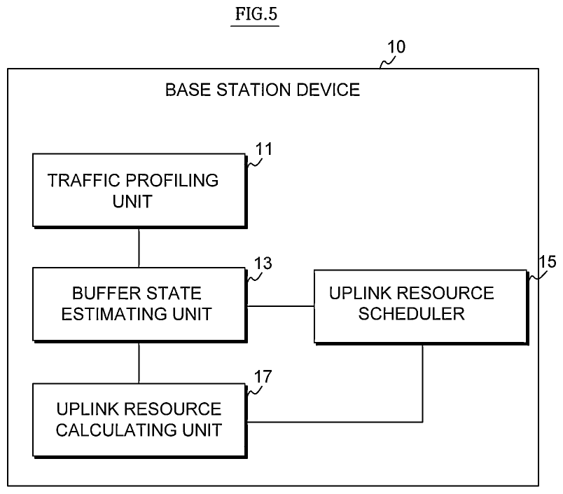

FIG. 4 shows an exemplary comparison between buffer states in reactive scheduling and preemptive scheduling. FIG. 4 A shows a simple example of the responsive scheduling after data arrives to a buffer of the mobile terminal 20 (t and t+1). In FIG. 4A, after one data block starts to fill the buffer at a time point t, and two data blocks additionally fill the block at a time point t+1 so that a total of three data blocks are stored in the buffer. In response to a resource allocation request of the mobile terminal 20, a transmission block is allocated from the BS, and a final data block is transmitted at a time point t+6. Here, a solid line box indicates that a data block is transmitted through the allocated transport block. Likewise, FIG. 4B shows an example of the preemptive scheduling. The reactive scheduling and the preemptive scheduling which have a delay in resource allocation allocate resources based on buffer estimation as soon as the buffer is filled. However, a resource exceeding the buffer may be allocated due to an overestimation error which is shown as Estimation error. The preemptive scheduling indicates that a buffer state that requires 4 transmission blocks is predicted at a time point t+1, a transmission block is preemptively allocated, and all data in the buffer is transmitted at a time point t+1.

The BS device 10 that allocates an uplink resource through buffer estimation according to one aspect of the present invention includes a traffic profiling unit 11, a buffer state estimating unit 13, and an uplink resource scheduler 15.

The traffic profiling unit 11, the buffer state estimating unit 13, and the uplink resource scheduler 15 are operated in the MAC layer of the BS device 10.

The traffic profiling unit 11 profiles traffic received from the mobile terminal 20 allocated with an uplink resource. The traffic profiling unit 11 profiles a packet, that is, traffic, transmitted by the mobile terminal 20 allocated with an uplink resource, that is, a transmission block, according to an SR or a BSR. That is, the traffic profiling unit 11 identifies a traffic pattern, which is transmitted by an application running on the mobile terminal 20, through traffic profiling. For example, when the mobile terminal 20 transmits traffic through RTC, the traffic profiling unit 11 identifies a traffic pattern, in which traffic is periodically transmitted, from a timing and amount of inflow of traffic.

The traffic profiling unit 11 may recognize RTC with a traffic pattern that periodically repeats on- and off-periods, may identify a length of the on-period, a length of the off-period, and an amount of traffic in the on-period, and may perform profiling with information including the length of the on-period, the length of the off-period, and the amount of traffic.

In this case, the amount of traffic in the on-period may be an average value obtained by dividing the traffic in the on-period divided by the length of the on-period.

Since a traffic pattern is changed according to an application or an operation of a transmission layer, it is difficult for the traffic profiling unit 11 to predict an exact arrival timing and amount of traffic, and thus profiling is performed using a general traffic pattern of RTC. That is, the traffic profiling unit 11 profiles a traffic arrival to obtain a period length of each on-period and an amount of the traffic arrival, thereby modeling a traffic pattern of an RTC application.

The traffic profiling unit 11 of the BS device 10 according to another aspect of the present invention may profile traffic from buffer size information included in an uplink resource allocation request received from the mobile terminal 20.

In the present aspect, the traffic profiling unit 11 may profile a traffic pattern by estimating an amount of a traffic arrival from buffer size information included in an SR and a BSR received discontinuously from the mobile terminal 20.

The buffer state estimating unit 13 predicts a traffic pattern based on the traffic profiling and preemptively estimates a buffer state according to the prediction.

The buffer state estimating unit 13 identifies an on-time period and an amount of a traffic arrival through traffic profiling and then probabilistically preemptively estimates a buffer state according to a traffic pattern of RTC of the current mobile terminal 20. In this case, the buffer state estimating unit 13 may estimate a small amount of buffer in an off-period and predicts a deluge of traffic arrivals in an on-period to estimate a large amount of buffer.

The BS device 10 which allocates an uplink resource through buffer estimation according to one aspect of the present invention generates a statistical model indicating a probability that one period continues. A CDF of the statistical model is a probability that a corresponding period ends. In the present invention, a statistical probability model of a truncated Gaussian distribution may be generated through a history of a previous on-period. The reason for using the truncated Gaussian distribution in the present invention is that in the case of a traffic pattern in RTC, a probability of switching to a next period rapidly increases over time as compared to when an on- or off-period is first changed.

The buffer state estimating unit 13 calculates an expected traffic arrival amount for each on-period. In order to obtain an average traffic arrival trend, the buffer state estimating unit 13 uses a moving average, in which a traffic arrival amount is exponentially weighted, as the expected traffic arrival amount. This is calculated as eAₜ=αAₜ₋₁+(1−α)eAₜ₋₁ during an on-period. Here, eAₜ is the expected traffic arrival amount at a time point t, and a is a smoothing constant basically set to 0.25. In addition, a traffic arrival amount is probabilistically predicted using a statistical model for each period. During an on-period, it is assumed that packets are received in all slots by the average traffic arrival amount. By using a statistical model, when a cumulative probability of a length of a current on-period is greater than 0.8, the on-period is considered to be ended, and traffic is assumed to no longer arrive. During an off-period, it is considered that a packet is present in a buffer according to a value obtained by multiplying a cumulative probability of a statistical model by eAₜ. Therefore, a resource may be allocated quickly even when traffic arrives earlier due to incorrect prediction or a change in CCA.

When a traffic pattern periodically repeats an on- and off-periods, the buffer state estimating unit 13 may perform an estimate such that a buffer size gradually increases during the off-period. This allows the buffer state estimating unit 13 to estimate an amount of next traffic through traffic profiling, but allows a resource to be quickly allocated even when traffic arrives earlier than expected due to the above-described causes (incorrect prediction or a change in CCA).

The uplink resource scheduler 15 preemptively allocates an uplink resource to the mobile terminal 20 according to a buffer state estimated by the BS device 10.

When a buffer state is preemptively estimated, the uplink resource scheduler 15 preemptively allocates a radio resource to the mobile terminal 20. That is, even when the BS device 10 does not receive an uplink radio resource request (SR or BSR) from the mobile terminal 20, the BS device 10 preemptively allocates a radio resource according to an estimated buffer state and transmits an uplink grant to transmit information about a radio resource (transmission block) to be allocated.

Even when the BS device 10 estimates a buffer state, the BS device 100 may receive an SR or BSR from the mobile terminal 20 before preemptively allocating a resource. Even in this case, the BS device 10 may preemptively allocate an uplink resource to the mobile terminal 20 according to the estimated buffer state.

Since the BS device 10 estimates the buffer state based on a predicted traffic pattern, when the prediction is incorrect, a radio resource may be wasted. Therefore, even when the BS device 10 estimates the buffer state and preemptively allocates a resource, it is necessary to ensure that a radio resource of the BS device 10 is not wasted. That is, the BS device 10 requires a method of maximizing an advantage of preemptively allocating a resource through preemptive buffer state estimation and simultaneously minimizing the waste of resources.

The BS device 10 which allocates an uplink resource through buffer estimation according to one aspect of the present invention may further include an uplink resource calculating unit 17.

The BS device 10 may know a buffer state of the mobile terminals 20 through a resource allocation request (SR or BSR) received from the mobile terminals 20. The known buffer state may be referred to as a reported buffer state and may be considered as a certain buffer state that should be allocated to the mobile terminal 20 by the BS device 10.

A buffer state of the mobile terminal 20, which performs RTC, estimated by the BS device 10, may be referred to as an estimated buffer state and may be considered as an uncertain buffer state.

After a buffer state is estimated, the uplink resource calculating unit 17 may calculate an amount of an uplink resource to be preemptively allocated based on an amount of an uplink resource requested to be allocated according to an amount of an allocatable uplink resource and a buffer state reported through a BSR.

In this case, the uplink resource scheduler 15 may first allocate the uplink resource requested through the BSR and then may preemptively and additionally allocate an uplink resource in a range of the calculated amount of the uplink resource to be preemptively allocated.

As described above, the BS device 10 may distinguish a certain buffer state from an uncertain buffer state and may generate two virtual buffer sets such as a certain buffer set and an uncertain buffer set.

In order to prevent resource waste due to incorrect prediction when a radio resource is allocated to the mobile terminal 20 according to an estimated buffer state, the uplink resource scheduler 15 may first allocate a resource to the certain buffer set and then may allocate a resource to the uncertain buffer set in a range of remaining allocable radio resources.

That is, the uplink resource scheduler 15 sequentially allocates resources to the certain buffer set and the uncertain buffer set. Therefore, the uplink resource scheduler may allocate a resource to the uncertain buffer set only when there are the remaining resources after a resource is allocated to the certain buffer set.

According to a BS device of the present invention, packets of a video-based real-time communication application can be transmitted without delay through preemptive radio resource allocation using buffer estimation.

In addition, according to a BS device of the present invention, even when a radio resource is preemptively allocated through buffer estimation, resource waste due to uncertain estimation can be minimized.

While the present invention has been described above with embodiments in conjunction with the accompanying drawings, the present invention is not limited thereto and should be interpreted to cover various modifications that will be apparent to those of ordinary skill in the art. The claims are intended to cover such modifications.

What is claimed is:

1. A method of allocating an uplink resource in a base station device, the method comprising:
a traffic profiling operation of profiling traffic received from a mobile terminal allocated with an uplink resource;
a buffer state estimating operation of predicting a traffic pattern based on the traffic profiling and preemptively estimating a buffer state according to the predicting; and
an uplink resource allocating operation of preemptively allocating an uplink resource to the mobile terminal according to the estimated buffer state.

2. The method of claim 1, further comprising, after the buffer state estimating operation, a preemptive uplink resource calculating operation of calculating an amount of an uplink resource to be preemptively allocated based on an amount of an uplink resource requested to be allocated according to an amount of an allocatable uplink resource and a buffer state reported through a buffer state report (BSR),
wherein, in the uplink resource allocating operation, the uplink resource requested through the BSR is first allocated, and then the uplink resource is preemptively and additionally allocated in a range of the calculated amount of the uplink resource to be preemptively allocated.

3. The method of claim 1, wherein, in the traffic profiling operation, a traffic pattern that periodically repeats on- and off-periods is profiled with information including a length of the on-period, a length of the off-period, and an amount of traffic in the on-period.

4. The method of claim 3, wherein, in the buffer state estimating operation, an estimate is performed such that a buffer size gradually increases during the off-period.

5. The method of claim 1, wherein, in the traffic profiling operation, the traffic is profiled from buffer size information included in an uplink resource allocation request received from the mobile terminal.

6. A base station device for allocating an uplink resource through buffer estimation, the base station device comprising:
a traffic profiling unit configured to profile traffic received from a mobile terminal allocated with an uplink resource;
a buffer state estimating unit configured to predict a next traffic pattern based on the traffic profiling and preemptively estimate a buffer state according to the prediction; and
an uplink resource scheduler configured to preemptively allocate an uplink resource to the mobile terminal according to the estimated buffer state.

7. The base station device of claim 6, further comprising an uplink resource calculating unit configured to, after the buffer state is estimated, calculate an amount of an uplink resource to be preemptively allocated based on an amount of an uplink resource requested to be allocated according to an amount of an allocatable uplink resource and a buffer state reported through a buffer state report (BSR),
wherein the uplink resource scheduler preemptively allocates the uplink resources in a range of the calculated amount of the uplink resources to be preemptively allocated.

8. The base station device of claim 6, wherein the traffic profiling unit profiles a traffic pattern, which periodically repeats on- and off-periods, with information including a length of the on-period, a length of the off-period, and an amount of traffic in the on-period.

9. The base station device of claim 8, wherein the buffer state estimating unit performs an estimate such that a buffer size gradually increases during the off-period.

10. The base station device of claim 6, wherein the traffic profiling unit profiles the traffic from buffer size information included in a resource allocation request received from the mobile terminal.
